(19) United States
(12) Patent Application Publication
(10) Pub. No.: US 2018/0361928 A1
(43) Pub. Date: Dec. 20, 2018

(54) SYSTEM FOR CONTROLLING OPERATION SOUND OF TURN SIGNAL LAMP OF VEHICLE

(71) Applicant: 1THEFULL PLATFORM LIMITED, Seoul (KR)

(72) Inventor: Seung Yub KOO, Gyeonggi-do (KR)

(21) Appl. No.: 15/781,375

(22) PCT Filed: Nov. 16, 2016
(86) PCT No.: PCT/KR2016/013219

§ 371 Date: Jun. 4, 2018

(30) Foreign Application Priority Data
Dec. 3, 2015 (KR) 10-2015-0171737

(51) Int. Cl. B60Q 9/00; B60Q 1/34

(52) U.S. Cl. CPC B60Q 9/00; B60Q 1/34

(57) ABSTRACT

A system for controlling an operation sound of a turn signal lamp of a vehicle may enable a stable operation of a vehicle by automatically controlling an operation sound generated by operating a turn signal lamp when the vehicle is stopped. For example, the system includes a direction selection switch to select an operation direction of the turn signal lamp, a sound emitting unit to emit an operation sound, an operation state detection unit to detect a stop state and a running state of the vehicle, and a sound emission control unit to control the operation sound to be temporarily silent or have a reduced volume when the vehicle is in a stop state while the operation sound is being emitted through the sound emitting unit and to control the operation sound to be emitted through the sound emitting unit when the vehicle is in a running state.

### TECHNICAL FIELD

An embodiment of the present disclosure relates to a system for controlling an operation sound of a turn signal lamp of a vehicle.

### BACKGROUND ART

Generally, a turn signal lamp installed at a vehicle is a lamp flickering device for informing other vehicles of a turning direction of the vehicle. The turn signal lamp is installed at front, rear, right and left sides of the vehicle, and an indicator is installed at an instrument panel at the interior of the vehicle so that a driver may check whether the turn signal lamp is normally operating. In addition, if the vehicle turns and then the steering wheel is rotated in a linear direction, the turn signal lamp is automatically stopped.

Accordingly, when the driver turns the vehicle in any direction, if the driver operate a direction selection switch before a turning point, a battery power source operates a flicker timer and simultaneously turns on the turn signal by turning on/off a contact point of a switching element, and the indicator at the instrument panel is flickered.

In addition, when the switching element is normally turned on/off, a mechanical contact sound (hereinafter, referred to as an operation sound) is generally generated constantly, so that the driver may check that the turn signal lamp is turned on by the sound.

When the vehicle is running, the operation sound is mixed with engine noise or indoor noise of the vehicle, which thus does not give a serious problem. However, if the vehicle is stopped or at standstill, the operation sound is often perceived as noise that irritates to the ear since the indoor of the vehicle is relatively quiet.

Moreover, considering the unmanned automobile industry in the future, the passengers do not have to listen to the operation sound when the vehicle is stopped or at standstill, and thus it is required to adjust the operation sound appropriately.

### DISCLOSURE

### Technical Problem

An embodiment of the present disclosure is directed to providing a system for controlling an operation sound of a turn signal lamp, which may enable a more stable operation of a vehicle by automatically controlling an operation sound generated by operating a turn signal lamp when the vehicle is stopped or at standstill.

### Technical Solution

In one general aspect, there is provided a system for controlling an operation sound of a turn signal lamp of a vehicle, comprising: a direction selection switch configured to select an operation direction of the turn signal lamp; a sound emitting unit controlled by the selection of the direction selection switch to emit a predetermined operation sound; an operation state detection unit configured to detect a stop state and a running state of the vehicle; and a sound emission control unit configured to control the operation sound emitted through the sound emitting unit to be temporarily silent or have a reduced volume when the operation state detection unit detects that the vehicle is in a stop state while the operation sound is being emitted through the sound emitting unit and to control the operation sound to be emitted through the sound emitting unit when the operation state detection unit detects that the vehicle is in a running state.

In addition, an ISG (Idle Stop and Go: ISG) system may be mounted to the vehicle, the operation state detection unit may work in association with the ISG system to receive an engine stop signal or an engine start signal from the ISG system, and the sound emission control unit may control the operation sound emitted through the sound emitting unit to be temporarily silent or have a gradually reduced volume when the operation state detection unit receives the engine stop signal and control the operation sound to be emitted through the sound emitting unit when the operation state detection unit receives the engine start signal.

In addition, the operation state detection unit may work in association with a brake system of the vehicle to receive a vehicle stop signal from the brake system when a brake negative pressure is equal to or greater than a predetermined value, and the sound emission control unit may control the operation sound emitted through the sound emitting unit to be temporarily silent or have a reduced volume when the operation state detection unit receives the vehicle stop signal and control the operation sound to be emitted through the sound emitting unit when the operation state detection unit does not receive the vehicle stop signal.

In addition, the operation state detection unit may work in association with a speed detection system of the vehicle to receive speed information of the vehicle from the speed detection system and determine a stop state and a running state of the vehicle based on the received speed information, and the sound emission control unit may control the operation sound emitted through the sound emitting unit to be temporarily silent or have a gradually reduced volume when the operation state detection unit determines that the vehicle is in a stop state and control the operation sound to be emitted through the sound emitting unit when the operation state detection unit determines that the vehicle is in a running state.

In addition, the sound emission control unit may include a volume adjusting unit configured to adjust a current amount output to the sound emitting unit according to the detection result of the operation state detection unit so that the operation sound is controlled to be silent or have a controlled volume.

In addition, the volume adjusting unit may control the operation sound to have a gradually reduced volume as the speed of the vehicle decreases based on the speed information and control the operation sound to be silent when the speed of the vehicle becomes 0.

In addition, the sound emission control unit may include a control switch that is turned on/off according to the detection result of the operation state detection unit to control the power supplied to the sound emitting unit.

In addition, the control switch may include a MOS transistor having a first terminal, a second terminal and a control terminal, the first terminal may be connected to a power supply unit, the second terminal may be connected to the sound emitting unit, and the control terminal may receive a control signal for turning on/off the control switch from the sound emission control unit according to the detection result of the operation state detection unit.

### Advantageous Effects

According to an embodiment of the present disclosure, the system for controlling an operation sound of a turn signal lamp may enable a more stable operation of a vehicle by automatically controlling an operation sound generated by operating a turn signal lamp when the vehicle is stopped or at standstill.

### DESCRIPTION OF DRAWINGS

FIG. 1 is a block diagram showing a system for controlling an operation sound of a turn signal lamp of a vehicle according to an embodiment of the present disclosure.

FIG. 2 is a block diagram showing a system for controlling an operation sound of a turn signal lamp, which operates in association with an ISG (Idle Stop and Go) system of a vehicle according to an embodiment of the present disclosure.

FIG. 3 is a block diagram showing a system for controlling an operation sound of a turn signal lamp, which operates in association with a brake system of a vehicle according to an embodiment of the present disclosure.

FIG. 4 is a block diagram showing a system for controlling an operation sound of a turn signal lamp, which operates in association with a speed detection system of a vehicle according to an embodiment of the present disclosure.

FIGS. 5 and 6 are block diagrams showing examples of the sound emission control unit.

### BEST MODE

The terms used herein will be briefly described, and the present disclosure will be described in detail.

The terms used in the present disclosure have chosen from general terms that are widely used at the present, in consideration of the functions in the present disclosure, but the terms may be varied depending on the intentions of those skilled in the art, the precedents or the emergence of new technologies. In addition, in a specific case, there may be a term arbitrarily selected by the applicant, and in this case, its meaning will be described in detail herein. Thus, the term used in the present disclosure should be defined based on the meaning of the term and the whole content of the present disclosure, not on a simple name of the term.

In the entire specification, if a component is described as “including” an element, it does not exclude the other elements but means that another element can be further included, unless specifically stated otherwise. Also, the terms such as “unit” and “module” used herein mean a unit for processing at least one function or operation, and this may be implemented by hardware or software or by a combination of hardware and software.

An embodiment of the present disclosure will be described in detail with reference to the accompanying drawings so as to be easily implemented by those skilled in the art. However, the present disclosure may be implemented in various different ways and is not limited to the embodiment described herein. In addition, in order to clearly explain the present disclosure, any portion of the drawings not related to the description is omitted, and like reference numerals are given to similar portions throughout the specification.

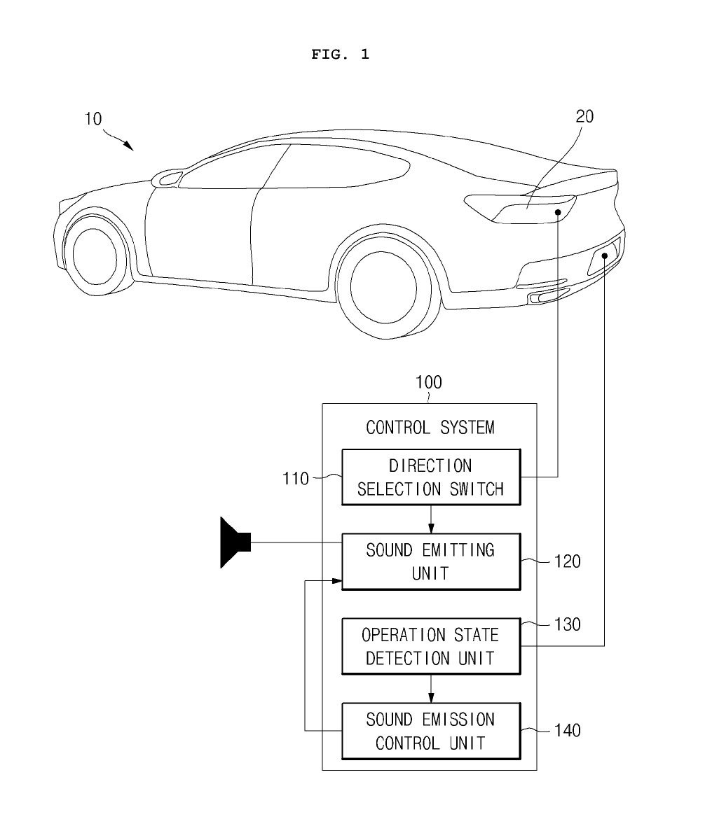

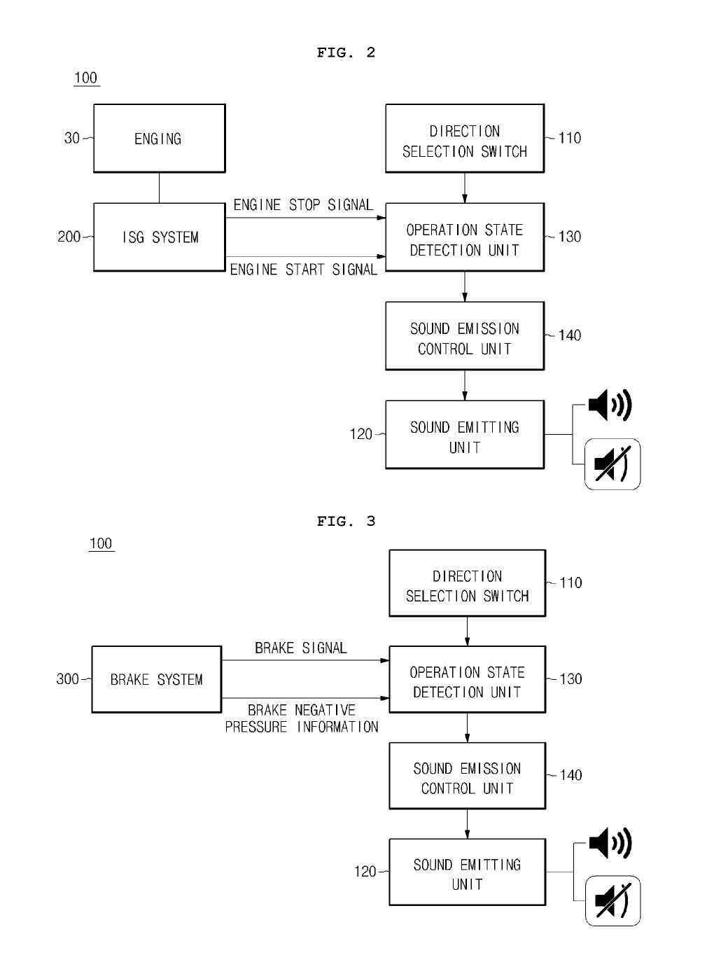

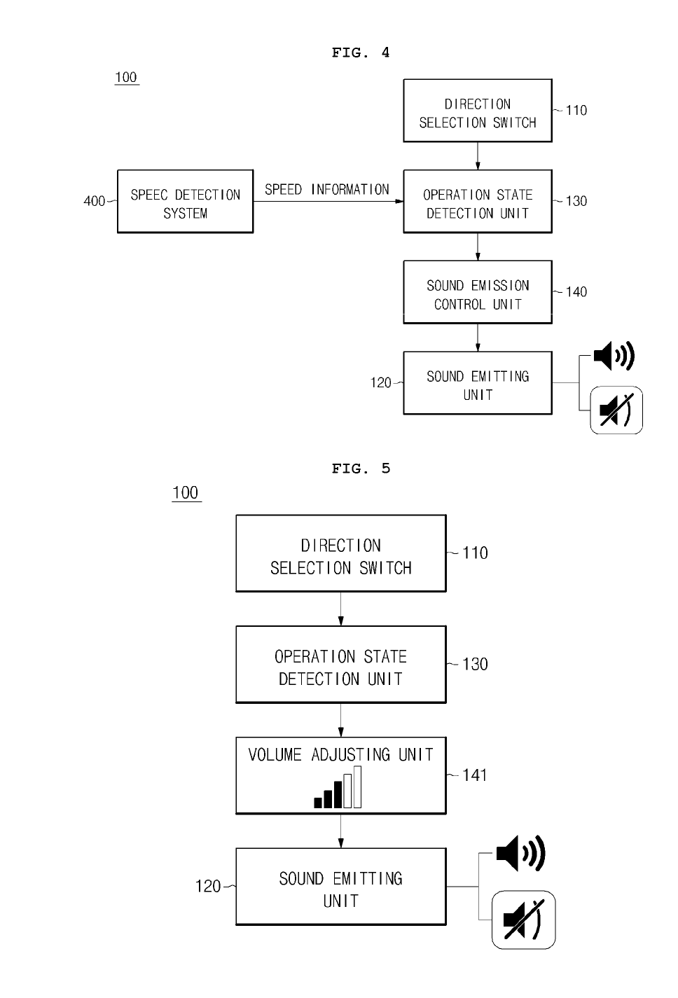

FIG. 1 is a block diagram showing a system for controlling an operation sound of a turn signal lamp of a vehicle according to an embodiment of the present disclosure, FIG. 2 is a block diagram showing a system for controlling an operation sound of a turn signal lamp, which operates in association with an ISG (Idle Stop and Go) system of a vehicle according to an embodiment of the present disclosure, FIG. 3 is a block diagram showing a system for controlling an operation sound of a turn signal lamp, which operates in association with a brake system of a vehicle according to an embodiment of the present disclosure, and FIG. 4 is a block diagram showing a system for controlling an operation sound of a turn signal lamp, which operates in association with a speed detection system of a vehicle according to an embodiment of the present disclosure.

Referring to FIGS. 1 to 4, a system 100 for controlling an operation sound of a turn signal lamp of a vehicle according to an embodiment of the present disclosure includes a direction selection switch 110, a sound emitting unit 120, an operation state detection unit 130 and a sound emission control unit 140.

The direction selection switch 110 is a means for selecting an operation direction of a turn signal lamp 20 and may include an operating lever (not shown) installed at a handle portion of a vehicle 10 and a switching circuit for flickering the turn signal lamp 20 according to the manipulation of the operating lever. If the operating lever is raised upwards, a right lamp of the turn signal lamp 20 may be flickered. If the operating lever is lowered, a left lamp of the turn signal lamp 20 may be flickered.

Meanwhile, the turn signal lamp 20 may employ a flasher turn signal lamp as a signal means for indicating a turning direction of the vehicle 10. The turn signal lamp 20 may be flickered by intermittently turning on and off the power. At this time, the flickering frequency may be about 90±30 Hz per minute, and the flickering signal may be generated within one second at the maximum after the direction selection switch 110 is operated.

The sound emitting unit 120 may be controlled by the selection of the direction selection switch 110 to emit a predetermined operation sound. Here, the operation sound may be a predetermined mechanical sound generated according to the flickering state of the turn signal lamp 20, such as a mechanical contact sound generated when a switching element is generally turned on/off.

The sound emitting unit 120 may include a speaker for emitting the operation sound according to a predetermined flickering frequency when the right or left turn signal lamp 20 is operated by the direction selection switch 110.

The operation state detection unit 130 may detect a stop state (or, a standstill state) and a running state of the vehicle 10 and provide the detection result to the sound emission control unit 140. The stop state (or, the standstill state) of the vehicle 10 may indicate a state where the vehicle temporarily stalls by an ISG (Idle Stop and Go) system or where the speed of the vehicle 10 becomes 0 km/h by stepping a brake pedal after the vehicle is started. In addition, the running state of the vehicle 10 may indicate a state where the vehicle is moving at a speed exceeding 0 km/h after the vehicle 10 is started.

The operation state detection unit 130 may detect the stop state (or, the standstill state) or the running state of the vehicle 10 in association with various systems mounted to the vehicle 10.

For example, as shown in FIG. 2, the operation state detection unit 130 may work in association with an ISG system 200 mounted to the vehicle 10. In this case, the operation state detection unit 130 may detect the stop state (or, the standstill state) or the running state of the vehicle 10 by receiving an engine stop signal or an engine start signal from the ISG system 200.

More specifically, if a driver steps on the brake pedal (not shown) to stop the vehicle 10, the ISG system 200 temporarily turns off an engine 30, and then generates an engine stop signal accordingly and transmits the engine stop signal to the operation state detection unit 130. Accordingly, the operation state detection unit 130 may detect that the vehicle 10 is in the stop state (or, the standstill state) by the engine stop signal received from the ISG system 200.

In addition, if a driver intends to start the vehicle 10 by releasing the brake pedal, the ISG system 200 may restart the engine 30 using a starter motor (not shown), and then generate an engine start signal accordingly and transmit the engine start signal to the operation state detection unit 130. Accordingly, the operation state detection unit 130 may detect that the vehicle 10 is in the running state by the engine start signal received from the ISG system 200.

In addition, as shown in FIG. 3, the operation state detection unit 130 may work in association with a brake system 300 of the vehicle 10. In this case, if a brake negative pressure detected through the brake system 300 is equal to or greater than a predetermined value, the operation state detection unit 130 may receive a vehicle stop signal from the brake system 300 and detect that the vehicle 10 is in the stop state (or, the standstill state) by the received vehicle stop signal. Here, if the brake negative pressure is equal to or greater than a predetermined value, this corresponds to a case where the brake pedal is sufficiently pressurized to stop the vehicle 10.

In addition, as shown in FIG. 4, the operation state detection unit 130 may work in association with a speed detection system 400. In this case, the operation state detection unit 130 may receive speed information of the vehicle 10 from the speed detection system 400 and determine the stop state (or, the standstill state) and the running state of the vehicle 10 based on the received speed information.

For example, if the speed of the vehicle 10 is decreasing from about 10 km/h to 0 km/h or is decreased to 0 km/h, the operation state detection unit 130 may determine based on the speed information that the vehicle 10 is in the stop state (or, the standstill state). In addition, if the speed of the vehicle 10 is maintained at about 10 km/h or above, the vehicle 10 may be determined as being in the running state.

If the vehicle 10 is detected as being in the stop state (or, the standstill state) by the operation state detection unit 130 in a state where an operation sound is being emitted through the sound emitting unit 120, the sound emission control unit 140 may control the operation sound emitted through the sound emitting unit 120 to be temporarily silent or have a reduced volume. If the vehicle is determined as being in the running state, the operation sound may be emitted through the sound emitting unit 120 as it is.

The sound emission control unit 140 may control the operation sound outputted from the sound emitting unit 120 according to each detection result of the operation state detection unit 130 as shown in FIGS. 2 to 4.

For example, as shown in FIG. 2, if the engine stop signal is received through the operation state detection unit 130, the sound emission control unit 140 may control the operation sound emitted through the sound emitting unit 120 to be temporarily silent or have a gradually reduced volume, and if the engine start signal is received, the operation sound may be emitted through the sound emitting unit 120 as it is.

In addition, as shown in FIG. 3, if the vehicle stop signal is received through the operation state detection unit 130, the sound emission control unit 140 may control the operation sound emitted through the sound emitting unit 120 to be temporarily silent or have a reduced volume, and if the vehicle stop signal is not received, the operation sound may be controlled to be emitted through the sound emitting unit 120 as it is. Here, if the vehicle stop signal is not received in the operation state detection unit 130, the sound emission control unit 140 may consider that the vehicle 10 is running, and then allow the operation sound to be emitted through the sound emitting unit 120 as it is. As described above, the sound emission control unit 140 may control the operation sound emitted through the sound emitting unit 120 depending on whether the vehicle stop signal is received.

In addition, as shown in FIG. 4, if it is determined through the operation state detection unit 130 that the vehicle 10 is in the stop state (or, the standstill state), the sound emission control unit 140 may control the operation sound emitted through the sound emitting unit 120 to be temporarily silent or have a gradually reduced volume, and if the vehicle is determined as being in the running state, the operation sound may be emitted through the sound emitting unit 120 as it is.

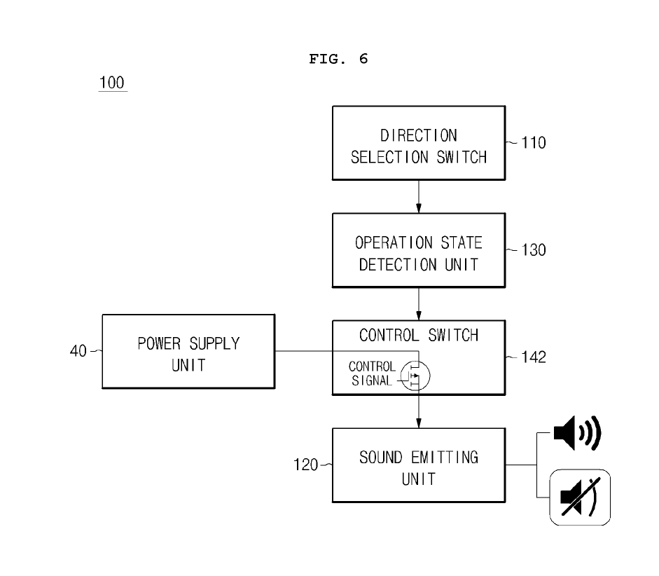

FIGS. 5 and 6 are block diagrams showing examples of the sound emission control unit 140.

The sound emission control unit 140 may include a volume adjusting unit 141 as shown in FIG. 5 or include a control switch 142 as shown in FIG. 6.

The volume adjusting unit 141 may control the operation sound to have a gradually reduced volume as the speed of the vehicle 10 decreases based on the speed information received from the speed detection system 400, and if the speed of the vehicle 10 becomes 0, the operation sound may be controlled to be silent.

For example, if the speed of the vehicle 10 is decreasing from about 10 km/h to 0 km/h, the volume adjusting unit 141 may control the operation sound to have a gradually reduced volume as the speed of the vehicle 10 is changed from 10 km/h to 0 km/h, and if the speed of the vehicle 10 becomes 0 km/h, the sound emitting unit 120 may be controlled so that the operation sound is completely silent.

After that, if the speed of the vehicle 10 exceeds about 10 km/h in a state where the turn signal lamp 20 is still turning on, the volume adjusting unit 141 may control the sound emitting unit 120 to output the operation sound as it is.

The control switch 142 may turn on/off according to the detection result of the operation state detection unit 130 to control the power supplied to the sound emitting unit 120 as shown in FIG. 6.

For example, the control switch 142 may include a MOS transistor having a first terminal, a second terminal and a control terminal. The first terminal of the MOS transistor 142 may be connected to a power supply unit 40, and the second terminal may be connected to the sound emitting unit 120.

The control terminal may receive a predetermined control signal from the sound emission control unit 140. Here, the control signal is an electric signal for turning on/off the control switch 142 from the sound emission control unit 140 according to the detection result of the operation state detection unit 130 and may include a first control signal for turning off the control switch 142 and a second control signal for turning on the control switch 142.

More specifically, if the vehicle 10 is detected as being in the stop state (or, the standstill state) through the operation state detection unit 130, the sound emission control unit 140 may output the first control signal to the control terminal of the MOS transistor 142 to turn off the MOS transistor 142 so that the power supplied to the sound emitting unit 120 is cut off. Accordingly, while the first control signal is being output from the sound emission control unit 140, the sound emitting unit 120 does not output an operation sound.

After that, if the vehicle 10 is detected as being in the running state through the operation state detection unit 130 while the turn signal lamp 20 is turning on, the sound emission control unit 140 may output the second control signal to the control terminal of the MOS transistor 142 to turn on the MOS transistor 142 so that the power may be supplied to the sound emitting unit 120. Accordingly, the sound emitting unit 120 may emit a predetermined operation sound as it is.

Meanwhile, the operation sound silencing function generated by operating the turn signal lamp as described above may be selectively used according to the selection of a user by adding a predetermined selection button for determining whether or not to operate the sound emission control unit 140.

The system 100 for controlling an operation sound of a turn signal lamp according to the present disclosure may be applied to an unmanned vehicle or a vehicle capable of operating in an automatic driving mode (or, an unmanned driving mode). For example, when the direction selection switch 110 of the control system 100 is firstly selected, the operation sound is heard only once, and after that, the volume of the operation sound may gradually decrease and become mute. After that, if the vehicle completely changes the lane or completely makes U-turn, it may be separately indicated that the operation of the turn signal lamp is completed, namely that the operation sound mute mode is completed, so that a driver or rider may confirm it. The completion of the operation sound mute mode may be indicated at a vehicle instrument panel by means of a separate lamp or by emitting a specific completion sound.

Accordingly, by automatically controlling the operation sound generated by operating the turn signal lamp to have a gradually reduced volume or be silent when the vehicle in a stopped state or in a standstill, it is possible to ensure more stable and comfortable driving without disturbing music appreciation or conversation between passengers inside the vehicle.

Merely one embodiment for implementing the system for controlling an operation sound of a turn signal lamp of a vehicle according to the present disclosure has been described, and it should be understood by those skilled in the art that the present disclosure can be modified in various ways without departing from the scope of the present disclosure as defined in the appended claims.

1. A system for controlling an operation sound of a turn signal lamp of a vehicle, comprising:
a direction selection switch configured to select an operation direction of the turn signal lamp;
a sound emitting unit controlled by the selection of the direction selection switch to emit a predetermined operation sound;
an operation state detection unit configured to detect a stop state and a running state of the vehicle; and
a sound emission control unit configured to control the operation sound emitted through the sound emitting unit to be temporarily silent or have a reduced volume when the operation state detection unit detects that the vehicle is in a stop state while the operation sound is being emitted through the sound emitting unit and to control the operation sound to be emitted through the sound emitting unit when the operation state detection unit detects that the vehicle is in a running state.

2. The system for controlling an operation sound of a turn signal lamp of a vehicle according to claim 1, wherein an idle stop and go (ISG) system is mounted to the vehicle;
the operation state detection unit works in association with the ISG system to receive an engine stop signal or an engine start signal from the ISG system; and
the sound emission control unit controls the operation sound emitted through the sound emitting unit to be temporarily silent or have a gradually reduced volume when the operation state detection unit receives the engine stop signal and controls the operation sound to be emitted through the sound emitting unit when the operation state detection unit receives the engine start signal.

3. The system for controlling an operation sound of a turn signal lamp of a vehicle according to claim 1, wherein the operation state detection unit works in association with a brake system of the vehicle to receive a vehicle stop signal from the brake system when a brake negative pressure is equal to or greater than a predetermined value; and
the sound emission control unit controls the operation sound emitted through the sound emitting unit to be temporarily silent or have a reduced volume when the operation state detection unit receives the vehicle stop signal and controls the operation sound to be emitted through the sound emitting unit when the operation state detection unit does not receive the vehicle stop signal.

4. The system for controlling an operation sound of a turn signal lamp of a vehicle according to claim 1, wherein the operation state detection unit works in association with a speed detection system of the vehicle to receive speed information of the vehicle from the speed detection system and determines a stop state and a running state of the vehicle based on the received speed information; and
the sound emission control unit controls the operation sound emitted through the sound emitting unit to be temporarily silent or have a gradually reduced volume when the operation state detection unit determines that the vehicle is in a stop state and controls the operation sound to be emitted through the sound emitting unit when the operation state detection unit determines that the vehicle is in a running state.

5. The system for controlling an operation sound of a turn signal lamp of a vehicle according to claim 1, wherein the sound emission control unit includes a volume adjusting unit configured to adjust a current amount output to the sound emitting unit according to the detection result of the operation state detection unit so that the operation sound is controlled to be silent or have a controlled volume.

6. The system for controlling an operation sound of a turn signal lamp of a vehicle according to claim 5, wherein the volume adjusting unit controls the operation sound to have a gradually reduced volume as the speed of the vehicle decreases based on the speed information and controls the operation sound to be silent when the speed of the vehicle becomes 0.

7. The system for controlling an operation sound of a turn signal lamp of a vehicle according to claim 1, wherein the sound emission control unit includes a control switch that is turned on/off according to the detection result of the operation state detection unit to control the power supplied to the sound emitting unit.

8. The system for controlling an operation sound of a turn signal lamp of a vehicle according to claim 1, wherein the control switch includes a MOS transistor having a first terminal, a second terminal and a control terminal;
the first terminal is connected to a power supply unit;
the second terminal is connected to the sound emitting unit; and
the control terminal receives a control signal for turning on/off the control switch from the sound emission control unit according to the detection result of the operation state detection unit.
